(19) United States
(12) Patent Application Publication
(10) Pub. No.: US 2020/0352200 A1
(43) Pub. Date: Nov. 12, 2020

(54) Rice Conditioning Process and Production Method of Instant Rice

(71) Applicant: Jiangnan University, Wuxi (CN)

(72) Inventors: Yaoqi TIAN, Wuxi (CN); Zhengyu JIN, Wuxi (CN); Rongrong MA, Wuxi (CN); Jinling ZHAN, Wuxi (CN); Long CHEN, Wuxi (CN); Canxin CAI, Wuxi (CN)

(21) Appl. No.: 16/940,454

(22) Filed: Jul. 28, 2020

Related U.S. Application Data
(63) Continuation of application No. PCT/CN2019/108421, filed on Sep. 27, 2019.

(30) Foreign Application Priority Data
Aug. 8, 2019 (CN) 2019107302912

(51) Int. Cl. A23L 7/196; A23L 5/10; A23B 9/02; A23B 9/10

(52) U.S. Cl. CPC A23L 7/1965; A23L 5/13; A23V 2002/00; A23B 9/10; A23B 9/02

(57) ABSTRACT

The present disclosure discloses a rice conditioning process and a production method of instant rice, and belongs to the technical field of food processing. According to the present disclosure, rice conditioning pretreatment is realized on the basis of an instantaneous high-temperature fluidization technology, and a conditioning liquid containing compounded soft rice flour, edible oil and rice soup is prepared through a rice soup backfilling technology. A technology of rapid cooling for film forming is adopted to increase a water-retaining film on the surface of rice, so as to enhance the water-retaining property, viscoelasticity and luster of the rice. The method mainly includes the steps of rice washing and draining, conditioning, cooking, aseptic packaging and rapid cooling for film forming. According to the present disclosure, industrialized continuous production can be realized, and the obtained instant rice is sticky but not adhesive after being stored for 60 days, and has a good taste.

### TECHNICAL FIELD

The present disclosure relates to a rice conditioning process and a production method of instant rice, and belongs to the technical field of food processing.

### BACKGROUND

With the development of economy and the accelerating of pace of life, the demand of people for instant food surges, and the instant food has been developed rapidly. Instant rice has a production history of several decades, and there are many varieties. It can be eaten directly or simply cooked before eating, and has the advantages of being easy to carry, safe, sanitary and the like. However, instant rice on the current market generally has the problems of adhesion and poor taste, which affects its taste quality and consumer acceptance, and limits its industrialization development. The factors that affect the taste of the instant rice mainly include: the thickness and smoothness of a water-retaining film on the surfaces of rice grains after cooking, and the viscoelasticity, hardness and the like of the rice grains. The instant rice is prone to increasing in hardness, decreasing in viscosity, and deteriorating in taste due to aging and water loss in long-time storage. Although scientific research generally believes that amylopectin retrogradation is reversible and can be eliminated when rice is reheated, the deteriorated taste of the rice after reheating is still irreversible.

Soft rice is a novel high-quality rice resource with low amylose content. It is rich in nutrition and has good cooking quality. Cold rice can still keep the soft texture and rich luster, which can give the rice better appearance and soft taste. In the cooking process of rice, free amylose and part of amylopectin in rice grains absorb water and swell to be dissolved out; the amylose easily forms an amylose-lipid complex with grease; and amylose molecules polymerize with each other, making the structure of the rice grains tighter, the whole structure of rice looser and non-adhesive, and the integrity and the discreteness of the rice grains higher. Grease may form a lipid film on the surfaces of the rice grains to increase the hydrophobicity, so water in the rice grains cannot be easily lost and is easier to be retained effectively, which gives rice good luster. As the cooking process progresses, the water evaporates and dissipates, and dissolved starch gradually wraps the surfaces of the rice grains to form an adhesive layer, that is, the water-retaining film of the rice, and the thickness and smoothness of the water-retaining film are the key factors affecting the taste of the rice. Instantaneous high-temperature fluidization treatment can make the surfaces of the rice grains to be unsmooth or produce fine cracks, which helps the surfaces of the rice grains to adsorb components of a conditioning liquid; and the rapid cooling rate makes the starch be gelled before forming a spiral structure, which helps increasing the water-retaining film on the surface of the rice. Soft rice, edible oil and rice soup are cheap and easy to obtain. Therefore, the present disclosure prepares the conditioning liquid based on soft rice, edible oil and rice soup, and adopts a technology of rapid cooling for film forming to improve the taste of instant rice, particularly, to promote a cheap indica rice raw material which is poor in taste and commonly used for feed production, so as to realize application of the indica rice to industrial production of instant rice.

### SUMMARY

In order to solve the above problems, the present disclosure adopts an instantaneous high-temperature fluidization technology combined with a rice soup backfilling process to prepare a conditioning liquid compounded with soft rice flour, edible oil and rice soup to perform conditioning pretreatment on rice, and the rice is treated by adopting a technology of rapid cooling for film forming after being cooked, which may remarkably improve the taste of instant rice with indica rice as a raw material.

The first objective of the present disclosure is to provide a rice conditioning process. The conditioning process includes instantaneous high-temperature fluidization treatment and conditioning liquid soaking treatment. A conditioning liquid contains soft rice flour, edible oil and rice soup.

In one embodiment of the present disclosure, the edible oil includes palm oil, peanut oil and soybean oil.

In one embodiment of the present disclosure, a mass ratio of the soft rice flour to the edible oil to rice is (0.05-0.1):(0.03-0.05):1.

In one embodiment of the present disclosure, conditions of the instantaneous high-temperature fluidization treatment are: the fluidization temperature is 130-160° C. and the fluidization time is 30-80 s.

The second objective of the present disclosure is to provide a preparation method of instant rice. According to the method, rice is subjected to instantaneous high-temperature fluidization treatment firstly, and then subjected to conditioning pretreatment by using a conditioning liquid compounded with soft rice flour, edible oil and rice soup, and cooking and cooling for film forming are performed to obtain the instant rice.

In one embodiment of the present disclosure, the method includes the following steps:

(1) washing rice, and draining the rice after washing;

(2) conditioning: firstly performing instantaneous high-temperature fluidization pretreatment on the rice, and then preparing a rice soup conditioning liquid containing soft rice flour and edible oil through a rice soup backfilling process, wherein the rice is soaked by the conditioning liquid for 10-20 min under 40-60° C.;

(3) cooking: cooking the rice treated in step (2), taking 20-30% of rice soup to prepare a new conditioning liquid when the temperature reaches 80-90° C., continuing cooking the rest of the rice soup for 20-30 minutes to obtain rice, and performing aseptic packaging; and

(4) rapidly cooling the rice obtained in step (3) to form a film.

In one embodiment of the present disclosure, conditions of pretreatment with the instantaneous high-temperature fluidization technology are: the fluidization temperature is 130-160° C. and the fluidization time is 20-60 s.

In one embodiment of the present disclosure, the rice soup in step (2) is the rice soup in the cooking process of step (3) and is obtained through the backfilling process.

In one embodiment of the present disclosure, a mass ratio of the soaked rice to water in the conditioning liquid in step (3) is 1:(1.5-2).

In one embodiment of the present disclosure, cooling for film forming in step (5) includes rapidly cooling the rice to 0-4° C. at the temperature of −80° C. to −20° C. at a rapid cooling rate of 10-14° C./min.

In one embodiment of the present disclosure, cooling modes adopted by cooling for film forming include, but are not limited to, air cooling and cold storage cooling.

The third objective of the present disclosure is to provide application of the above conditioning process in indica rice.

The fourth objective of the present disclosure is to provide instant rice prepared by the above method.

The fifth objective of the present disclosure is to provide application of the above conditioning process in cooking rice, coarse cereal rice and extruding and restructuring rice.

The present disclosure has the following beneficial effects:

(1) The conditioning liquid compounded with the soft rice flour, the edible oil and the rice soup is prepared based on the instantaneous high-temperature fluidization technology and the rice soup backfilling technology; the conditioning liquid and pre-treated rice are uniformly mixed and soaked and then cooked together; and in combination with the technology of rapid cooling for film forming, the taste of the rice can be remarkably improved.

(2) The instantaneous high-temperature fluidization treatment can make the surfaces of rice grains to be unsmooth or produce fine cracks, which helps the surfaces of the rice grains to adsorb components of the conditioning liquid.

(3) Soft rice is rich in nutrition and has good cooking quality. Its amylose content and water absorption are low, and its viscosity is high, which helps to improve the viscoelasticity of rice. Grease can help the rice grains to be separated, and can be attached to the surfaces of the rice grains to reduce the water loss and give the rice good luster and smooth mouthfeel. The addition of the soft rice and the grease helps to enhance the flavor and texture characteristics of the rice.

(4) In the cooking process, starch dissolved out of the rice grains is uniformly distributed in the rice soup, and as the cooking progresses, water evaporates and a layer of water-retaining film is formed on rice. If rice soup with a certain concentration is directly added to a cooking liquid at the initial stage of cooking, starch is attached to the surfaces of the rice grains, which is more conducive to forming a smooth water-retaining film and increasing the thickness of the water-retaining film. A part of the cooked rice soup is taken out for cooking rice in the next stage, and industrial continuous production can be realized.

(5) Rapid cooling helps to change an instantaneous crystallization behavior of starch. Molecular chains of starch attached to the surfaces of the rice grains are gelled before forming a crystal because of a too fast cooling speed, which can not only reduce retrogradation of the starch, but also promote the starch to form a film on the surfaces of the rice grains, and increase the thickness of the water-retaining film on the surface of rice.

(6) The present disclosure can remarkably promote formation and smoothness of the water-retaining film on the surfaces of the rice grains, which can not only reduce water loss of the instant rice during storage, but also increase viscoelasticity of the rice, give the rice good luster, and keep the rice soft and tender. After the instant rice prepared by the present disclosure is stored for two months, each texture index has no significant difference (p>0.05), and the performance change is less than 10%.

### BRIEF DESCRIPTION OF FIGURES

FIG. 1 is a process flow diagram of the present disclosure.

FIG. 2 shows dissolution content of starch in rice soup.

### DETAILED DESCRIPTION

The following describes preferred examples of the present disclosure. It should be understood that the examples are for better explanation of the present disclosure and are not intended to limit the present disclosure.

1. Sensory evaluation: the sensory evaluation is performed according to standards of GB/T 15682-2008 “Inspection of grain and oils—Method for sensory evaluation of paddy or rice cooking and eating quality”. The details are as follows: a test is performed in a sensory evaluation laboratory and ten evaluators are selected. White porcelain plates are randomly numbered, about 50 g of reheated rice of different examples and comparative examples is taken and put into sensory cups, then the cups are put into the white porcelain plates, and the rice is eaten and evaluated while being hot. Indexes include appearance (color, luster, and integrity of rice grains), texture (viscosity, elasticity, and hardness), taste (purity and durability during chewing), and integrity (bulkiness and uniformity). The higher a sensory score, the more acceptable the rice, and sensory scores are recorded in Table 1.

2. Texture testing: texture characteristics of samples are measured with a texture analyzer. Samples are taken at different locations and each sample is tested 12 times, with the highest and lowest values removed. Measurement parameters are set as follows: a P/25 cylindrical probe is adopted, a descending speed of the probe before measurement and a return speed of the probe after measurement are 1.0 mm/s, a testing speed is 0.5 mm/s, a compression ratio is 50%, a trigger force value is Auto-10 g, and a data acquisition rate is 200 pps.

Soft rice flour is prepared by grinding Changzhou Jintan soft rice.

### Example 1

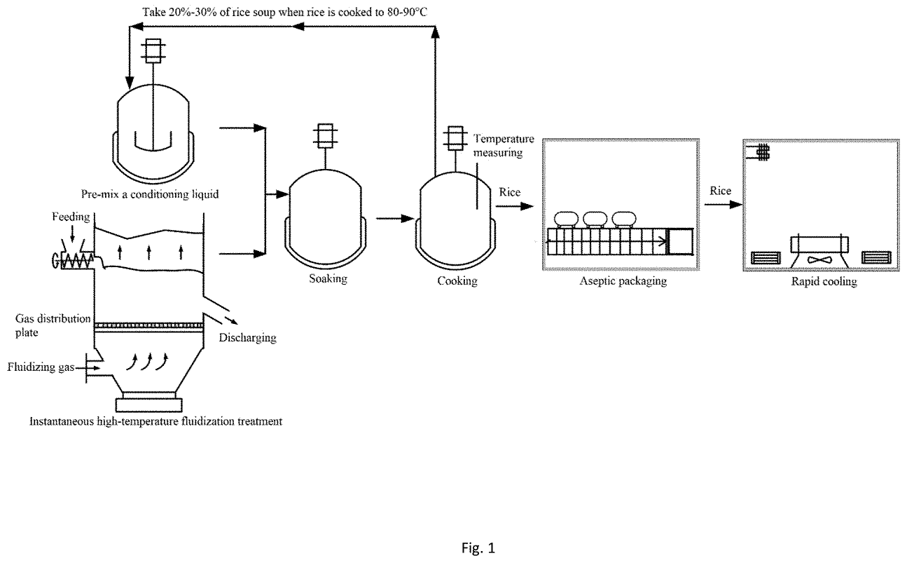

The process flow is shown in FIG. 1, and the specific steps are as follows:

(1) Rice is rapidly washed with drinking water and then drained.

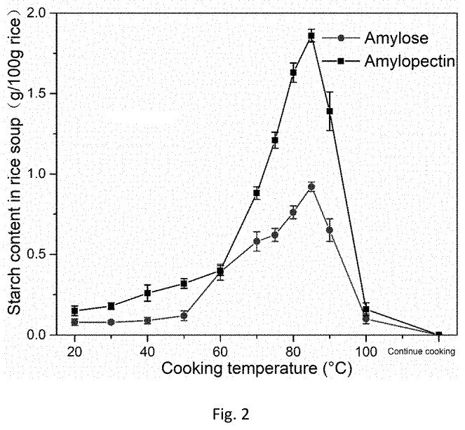

(2) Conditioning: instantaneous high-temperature fluidization pretreatment: raw materials are conveyed into a fluidization chamber, and subjected to fluidization treatment for 80 s under the condition of the fluidization temperature of 130° C. A conditioning liquid 1 containing soft rice flour, edible oil and water is prepared, wherein a mass ratio of the soft rice flour to the edible oil to the water is 0.05:0.05:1.5. After the conditioning liquid 1 is uniformly stirred by using a micro high-speed stirrer, the rice is soaked for 20 min according to a mass ratio of the rice to the water contained in the conditioning liquid 1 being 1:1.5. Through a rice soup backfilling process, it can be seen from FIG. 2 that when the cooking temperature is 90° C., the amylose content and the amylopectin content in rice soup are high, with a cooking temperature range of the rice soup with higher dissolution content as a soup taking point, 20% of the rice soup obtained by cooking to 90° C. is taken (the total amount of the rice soup can be obtained by draining to serve as a reference for subsequent production), and added into a new system to replace part of water. A conditioning liquid 2 is prepared at a proportion the same as that of the conditioning liquid 1, and the temperature of the whole system is maintained at about 50° C. After the conditioning liquid 2 is uniformly stirred by using the micro high-speed stirrer, the rice is soaked for 20 min by using the conditioning liquid 2.

(3) Cooking: 20% of the rice soup is taken for subsequent production when the cooking temperature reaches 90° C.; cooking continues for 25 min to obtain rice, and the rice is aseptically packaged.

(4) Cooling for film forming: in a low-temperature environment of −80° C., the rice is rapidly cooled in a cold storage cooling mode until the center temperature of the rice is cooled to 0° C., and an average cooling rate is 13° C./min. The rice is then placed in a refrigerator of 0° C. for storage. Compared with traditional instant rice, after 60-day storage, the obtained instant rice has lower hardness than a control group after reheating, is sticky but not adhesive, and has good sensory evaluation.

### Example 2

(1) Rice is rapidly washed with drinking water and then drained.

(2) Conditioning: instantaneous high-temperature fluidization pretreatment: raw materials are conveyed into a fluidization chamber, and subjected to fluidization treatment for 30 s under the condition of the fluidization temperature of 160° C. A conditioning liquid 1 containing soft rice flour, edible oil and water is prepared, wherein a mass ratio of the soft rice flour to the edible oil to the water is 0.1:0.03:2. After the conditioning liquid 1 is uniformly stirred by using a micro high-speed stirrer, the rice is soaked for 15 min according to a mass ratio of the rice to the water contained in the conditioning liquid 1 being 1:2. Through a rice soup backfilling process, 30% of rice soup obtained by cooking to 85° C. is taken (the total amount of the rice soup can be obtained by draining to serve as a reference for subsequent production), and added into a new system to replace part of water. A conditioning liquid 2 is prepared at a proportion the same as that of the conditioning liquid 1, and the temperature of the whole system is maintained at about 60° C. After the conditioning liquid 2 is uniformly stirred by using the micro high-speed stirrer, the rice is soaked for 15 min by using the conditioning liquid 2.

(3) Cooking: 30% of the rice soup is taken for subsequent production when the cooking temperature reaches 85° C.; cooking continues for 30 min to obtain rice, and the rice is aseptically packaged.

(4) Cooling for film forming: in a low-temperature environment of −70° C., the rice is rapidly cooled in an air cooling mode until the center temperature of the rice is cooled to 4° C., and an average cooling rate is 12° C./min. The rice is then placed in a refrigerator of 4° C. for storage. Compared with traditional instant rice, after 60-day storage, the obtained instant rice has lower hardness than a control group after reheating, is sticky but not adhesive, and has good sensory evaluation.

### Example 3

(1) Rice is rapidly washed with drinking water and then drained.

(2) Conditioning: instantaneous high-temperature fluidization pretreatment: raw materials are conveyed into a fluidization chamber, and subjected to fluidization treatment for 50 s under the condition of the fluidization temperature of 140° C. A conditioning liquid 1 containing soft rice flour, edible oil and water is prepared, wherein a mass ratio of the soft rice flour to the edible oil to the water is 0.08:0.04:1.8, and after the conditioning liquid 1 is uniformly stirred by using a micro high-speed stirrer, the rice is soaked for 10 min according to a mass ratio of the rice to the water in the conditioning liquid 1 being 1:1.8. Through a rice soup backfilling process, 25% of rice soup obtained by cooking to 80° C. is taken (the total amount of the rice soup can be obtained by draining to serve as a reference for subsequent production), and added into a new system to replace part of water. A conditioning liquid 2 is prepared at a proportion the same as that of the conditioning liquid 1, and the temperature of the whole system is maintained at about 40° C. After the conditioning liquid 2 is uniformly stirred by using the micro high-speed stirrer, the rice is soaked for 10 min by using the conditioning liquid 2.

(3) Cooking: 25% of the rice soup is taken for subsequent production when the cooking temperature reaches 80° C.; cooking continues for 25 min to obtain rice, and the rice is aseptically packaged.

(4) Cooling for film forming: in a low-temperature environment of −20° C., the rice is rapidly cooled in an air cooling mode until the center temperature of the rice is cooled to 2° C., and an average cooling rate is 11° C./min. The rice is then placed in a refrigerator of 0° C. for storage. Compared with traditional instant rice, after 60-day storage, the obtained instant rice has lower hardness than a control group after reheating, is sticky but not adhesive, and has good sensory evaluation.

Specific experimental data is shown in Table 1. By comparing the hardness, viscosity, elasticity, chewiness and sensory scores of rice of the control group and the three examples, the instant rice obtained by the examples is lower in hardness, higher in viscosity and elasticity, better in chewiness and obviously superior in sensory evaluation than the control group.

### Comparative Example 1

A preparation method of traditional instant rice includes the following steps: rice is rapidly washed with drinking water and drained; the rice is uniformly mixed with water at a mass ratio of 1:1.4, and is soaked for 15 min; and then the rice is cooked for 30 min, aseptically packaged, naturally cooled at the room temperature, stored for 60 days, and then subjected to sensory evaluation and texture characteristic analysis.

### Comparative Example 2

The rice soup backfilling process in Example 1 is omitted, while other conditions or parameters are consistent with those in Example 1, and then primary instant rice is obtained. Compared with Example 1, the instant rice has poor texture performance after being stored for 60 days, which indicates that the rice soup backfilling process is more conducive to forming a smooth water-retaining film and increasing the thickness of the water-retaining film.

### Comparative Example 3

The instantaneous high-temperature fluidization pretreatment in Example 1 is omitted, while other conditions or parameters are consistent with those in Example 1. Compared with Example 1, the hardness is high and viscosity and elasticity are decreased in the later storage period, which indicates that without the instantaneous high-temperature fluidization treatment, an adsorption effect of soft rice flour and edible oil on the surfaces of rice grains is poor.

### Comparative Example 4

A cooling rate in a patent with the publication number of CN108522999A is adopted, specifically, rice is rapidly cooled to 0° C. at a low-temperature environment of −80° C., and an average cooling rate is 5° C./min, while other conditions or parameters are consistent with those in Example 1. Compared with Example 1, texture performance of each aspect of freshly produced instant rice is similar to that of Example 1; however, after the rice is stored for 60 days, the texture performance of the rice is poorer than that of Example 1, which indicates that rapid cooling is conductive to changing an instantaneous crystallization behavior of starch. Molecular chains of starch attached to the surfaces of rice grains are gelled before forming a crystal because of a too fast cooling speed, which can not only reduces retrogradation of starch, but also promote the starch to form a film on the surfaces of the rice grains, increase the thickness of a water-retaining film on the surface of rice, and reduce a change of texture performance after long-term storage.

### Comparative Example 5

Conditions of the instantaneous high-temperature fluidization pretreatment are adjusted to the fluidization temperature of 200° C. and the fluidization time of 120 s, while other conditions or parameters are consistent with those in Example 1. Compared with Example 1, the prepared instant rice has decreased hardness and viscosity and poor taste after storage. The reasons are that the treatment temperature is too high and the treatment time is too long, which causes that the starch structure is damaged, the rice grains lose too much water, an internal compact structure is damaged, and the structure of the rice collapses after cooking. If the treatment time is too short and the treatment temperature is too low, a result of fluidization treatment may be poor and the desired effect cannot be achieved.

### Comparative Example 6

An addition amount of soft rice flour is adjusted to 0.2:1, while other conditions or parameters are consistent with those in Example 1. Compared with Example 1, the prepared instant rice is scattered in grain form and appears to be incomplete in particle. Too much soft rice flour cannot be completely and effectively attached to the surfaces of the rice grains, which results in softer and over-cooked taste, and poor elasticity and chewing feeling.

### Comparative Example 7

An addition amount of edible oil is adjusted to 0.1:1, while other conditions or parameters are consistent with those in Example 1. Compared with Example 1, the hardness of rice is increased, viscosity is remarkably decreased, an original taste is seriously covered by grease, and flavor deterioration is serious after storage. The reason is that if too much edible oil is added, a complex is formed by dissolved starch and lipid, which increases hydrophobicity of the starch, prevents water from entering starch granules, and limits water absorption and swelling of the starch in a gelatinization process. As a result, peak viscosity of the rice is decreased, the hardness is increased, and the viscosity is decreased. Excessive grease can easily generate a smell of grease oxidative rancidity in the storage process, which damages the original flavor of the rice. If too little edible oil is added, the effect is not significant enough.

TABLE 1
Texture analysis and sensory scores

| | | | | | | Sensory |
|---|---|---|---|---|---|---|
| Sample | | Hardness/g | Viscosity | Elasticity | Chewiness | score |
| Example 1 | 0 d | 429.24 ± 9.17^{d} | −8.64 ± 0.97^{b} | 0.77 ± 0.02^{b} | 315.54 ± 26.24^{def} | 87.25 ± 5.45^{a} |
| | 60 d | 438.36 ± 13.45^{d} | −8.35 ± 0.25^{b} | 0.76 ± 0.04^{b} | 339.27 ± 10.49^{de} | 83.05 ± 4.58^{a} |
| Example 2 | 0 d | 402.65 ± 24.46^{d} | −8.09 ± 0.38^{b} | 0.76 ± 0.08^{b} | 326.33 ± 14.76^{de} | 88.49 ± 2.98^{a} |
| | 60 d | 428.54 ± 49.27^{d} | −7.99 ± 1.12^{ab} | 0.79 ± 0.03^{b} | 379.62 ± 11.84^{cd} | 86.37 ± 3.06^{a} |
| Example 3 | 0 d | 415.81 ± 10.29^{d} | −8.22 ± 0.95^{b} | 0.72 ± 0.12^{ab} | 356.21 ± 15.87^{d} | 85.63 ± 2.19^{a} |
| | 60 d | 434.52 ± 65.84^{d} | −8.56 ± 0.73^{b} | 0.75 ± 0.02^{b} | 342.57 ± 28.13^{de} | 83.57 ± 6.66^{a} |
| Comparative | 0 d | 425.28 ± 15.22^{d} | −8.34 ± 0.99^{b} | 0.74 ± 0.05^{b} | 390.41 ± 13.45^{c} | 84.79 ± 3.24^{a} |
| example 1 | 60 d | 636.25 ± 57.21^{a} | −6.19 ± 1.23^{a} | 0.57 ± 0.07^{a} | 525.32 ± 29.38^{a} | 52.21 ± 2.56^{e} |
| Comparative | 0 d | 430.26 ± 11.78^{d} | −8.34 ± 0.49^{b} | 0.77 ± 0.08^{b} | 331.66 ± 12.39^{de} | 83.22 ± 2.34^{a} |
| example 2 | 60 d | 507.25 ± 22.28^{b} | −6.85 ± 1.01^{a} | 0.60 ± 0.07^{a} | 490.28 ± 15.53^{ab} | 58.19 ± 3.09^{d} |
| Comparative | 0 d | 422.09 ± 26.40^{d} | −8.66 ± 0.48^{b} | 0.75 ± 0.04^{b} | 327.90 ± 10.01^{e} | 85.36 ± 1.48^{a} |
| example 3 | 60 d | 480.57 ± 9.96^{c} | −6.45 ± 0.97^{a} | 0.59 ± 0.12^{ab} | 479.99 ± 9.26^{b} | 59.47 ± 3.17^{cd} |
| Comparative | 0 d | 419.85 ± 15.67^{d} | −8.27 ± 0.85^{b} | 0.78 ± 0.03^{b} | 313.20 ± 17.52^{ef} | 84.87 ± 4.31^{a} |
| example 4 | 60 d | 493.33 ± 21.11^{c} | −6.39 ± 0.64^{a} | 0.63 ± 0.02^{a} | 493.28 ± 14.44^{ab} | 63.28 ± 3.78^{cd} |
| Comparative | 0 d | 417.15 ± 12.27^{d} | −8.54 ± 0.52^{b} | 0.75 ± 0.03^{b} | 295.15 ± 10.12^{f} | 75.19 ± 2.51^{b} |
| example 5 | 60 d | 396.39 ± 19.89^{de} | −6.39 ± 0.82^{a} | 0.56 ± 0.06^{a} | 245.29 ± 8.33^{g} | 53.48 ± 4.21^{de} |
| Comparative | 0 d | 419.46 ± 9.87^{d} | −7.86 ± 0.73^{ab} | 0.57 ± 0.04^{a} | 292.34 ± 10.40^{f} | 76.34 ± 2.48^{b} |
| example 6 | 60 d | 382.47 ± 14.42^{e} | −6.44 ± 0.99^{a} | 0.52 ± 0.09^{a} | 262.79 ± 11.01^{g} | 64.59 ± 2.26^{c} |
| Comparative | 0 d | 439.81 ± 16.68^{d} | −8.24 ± 0.85^{b} | 0.75 ± 0.03^{b} | 316.33 ± 5.27^{e} | 75.21 ± 5.54^{ab} |
| example 7 | 60 d | 509.12 ± 10.66^{b} | −6.29 ± 0.56^{a} | 0.68 ± 0.05^{ab} | 359.83 ± 20.30^{cd} | 61.18 ± 2.27^{cd} |

Note:
Different lowercase letters in each column represent significant differences between values (p < 0.05).

In texture test results of rice, hardness reflects the hardness of rice grains, wherein moderate hardness is the best, and the hardness of instant rice tends to increase along with the storage time. Viscosity reflects work consumed by the viscosity of the rice grains when a test probe returns after leaving the rice grains, and depends on adhesive force, cohesive force, viscosity, viscoelasticity and the like. Elasticity reflects degrees to which the samples can recover after first compression. Chewiness simulates energy required to turn the rice grains into a steady state in which the rice grains can be swallowed, and is related to the hardness. The viscosity and elasticity have good relevance with eating quality of rice. In general, the greater absolute values of the viscosity and elasticity, the better the eating quality of rice. As shown in Table 1, compared with the comparative examples, the samples obtained in the examples have low hardness, high viscosity, high elasticity and good quality, and after the samples are stored for 60 days, texture indexes have no significant difference (p>0.05), and the change amount is less than 10%.

Although the present disclosure has been described in terms of exemplary embodiments, the exemplary embodiments are not intended to limit the present disclosure. Various changes and modifications can be made by those skilled in the art without departing from the spirit and scope of the present disclosure, and therefore the scope of protection of the present disclosure shall be defined in the appended claims.

What is claimed is:

1. A method of rice conditioning, comprising performing an instantaneous high-temperature fluidization treatment and a conditioning liquid soaking treatment using a conditioning liquid, wherein the conditioning liquid comprises soft rice flour, edible oil and a rice soup backfilled from a cooking unit to a soaking unit.

2. The method according to claim 1, wherein the instantaneous high-temperature fluidization treatment is performed at a fluidization temperature of 130-160° C. for a fluidization time of 30-80 second (s).

3. The method according to claim 1, wherein a mass ratio of the soft rice flour to the edible oil to rice is (0.05-0.1):(0.03-0.05):1.

4. A method for producing instant rice, comprising the steps of washing and draining rice, performing a treatment on the rice by using the method according to claim 1; cooking the rice; and cooling the rice to form a film to obtain the instant rice.

5. The method according to claim 4, comprising the following steps:
(1) washing rice, and draining the rice after washing;
(2) conditioning: firstly performing an instantaneous high-temperature fluidization pretreatment on the rice, and then preparing a rice soup conditioning liquid containing soft rice flour and edible oil through a rice soup backfilling process, wherein the rice is soaked in a conditioning liquid for 10-20 min under 40-60° C.;
(3) cooking: cooking the rice treated in step (2), taking 20%-30% of rice soup to prepare a new conditioning liquid when a temperature reaches 80-90° C., continuing cooking the rest of the rice soup for 20-30 min to obtain rice, and performing aseptic packaging; and
(4) rapidly cooling the rice obtained in step (3) to form a film.

6. The method according to claim 5, wherein:
the step (2) comprises the following steps: firstly performing the instantaneous high-temperature fluidization pretreatment on the rice, and then preparing the rice soup conditioning liquid containing soft rice flour and edible oil through the rice soup backfilling process, wherein a mass ratio of the soft rice flour to the edible oil to the rice is (0.05-0.1):(0.03-0.05):1, the rice is soaked in the conditioning liquid for 10-20 min under 40-60° C., and the instantaneous high-temperature fluidization treatment is performed at a fluidization temperature of 130-160° C. for the fluidization time of 30-80 s; (3) cooking: cooking the rice treated in step (2), taking 20%-30% of rice soup to prepare a new conditioning liquid when the temperature reaches 80-90° C., continuing cooking the rest of the rice soup for 20-30 min to obtain rice, and performing aseptic packaging; and
step (4) comprises rapidly cooling the rice obtained in the step (3) to 0-4° C. under −80° C. to −20° C. at a rapid cooling rate of 10-14° C./min.

7. The method according to claim 5, wherein the rice soup in the step (2) is the rice soup in the cooking process of the step (3), and is obtained by the backfilling process.

8. The method according to claim 5, wherein a mass ratio of the soaked rice to water in the conditioning liquid in the step (2) is 1:(1.5-2).

9. The method according to claim 5, wherein the step (4) comprises rapidly cooling the rice to 0-4° C. under −80° C. to −20° C. at a rate of 10-14° C./min, and cooling modes for cooling comprise air cooling and cold storage cooling.

10. The method according to claim 5, wherein:
step (1) comprises the following steps: rapidly washing rice with drinking water and then draining the rice;
the step (2) comprises the following steps: instantaneous high-temperature fluidization pretreatment: conveying raw materials into a fluidization chamber to be subjected to a fluidization treatment for 80 s at a fluidization temperature of 130° C.; preparing conditioning liquid 1 containing soft rice flour, edible oil and water, wherein a mass ratio of the soft rice flour to the edible oil to the water is 0.05:0.05:1.5; after the conditioning liquid 1 is uniformly stirred by using a micro high-speed stirrer, soaking the rice for 20 min according to a mass ratio of the rice to water contained in the conditioning liquid 1 being 1:1.5; through a rice soup backfilling process, cooking the rice to 90° C., taking 20% of rice soup obtained by cooking to be added into a new system to replace part of water, and preparing conditioning liquid 2 at a proportion the same as that of the conditioning liquid 1, wherein a temperature of the whole system is maintained at about 50° C.; and after the conditioning liquid 2 is uniformly stirred by using the micro high-speed stirrer, soaking the rice for 20 min by using the conditioning liquid 2;
the step (3) comprises the following steps: taking 20% of the rice soup for subsequent production when the cooking temperature reaches 90° C., continuing cooking for 25 min to obtain rice, and performing aseptic packaging; and
step (4) comprises the following steps: in a low-temperature environment of −80° C., rapidly cooling the rice in a cold storage cooling mode until a center temperature of the rice is cooled to 0° C., wherein an average cooling rate is 13° C./min, and then placing the rice in a refrigerator of 0° C. for storage.

11. The method according to claim 5, wherein:
step (1) comprises the following steps: rapidly washing rice with drinking water and then draining the rice;
the step (2) comprises the following steps: instantaneous high-temperature fluidization pretreatment: conveying raw materials into a fluidization chamber to be subjected to a fluidization treatment for 30 s at a fluidization temperature of 160° C.; preparing conditioning liquid 1 containing soft rice flour, edible oil and water, wherein a mass ratio of the soft rice flour to the edible oil to the water is 0.1:0.03:2; after the conditioning liquid 1 is uniformly stirred by using a micro high-speed stirrer, soaking the rice for 15 min according to a mass ratio of the rice to water contained in the conditioning liquid 1 being 1:2; through a rice soup backfilling process, taking 30% of rice soup obtained by cooking to 85° C. to be added into a new system to replace part of water, and preparing conditioning liquid 2 at a proportion the same as that of the conditioning liquid 1, wherein a temperature of the whole system is maintained at about 60° C.;
and after the conditioning liquid 2 is uniformly stirred by using the micro high-speed stirrer, soaking the rice for 15 min by using the conditioning liquid 2;
the step (3) comprises the following steps:: taking 30% of the rice soup for subsequent production when a cooking temperature reaches 85° C., continuing cooking for 30 min to obtain rice, and performing aseptic packaging; and
step (4) comprises the following steps: in a low-temperature environment of −70° C., rapidly cooling the rice in an air cooling mode until a center temperature of the rice is cooled to 4° C., wherein an average cooling rate is 12° C./min, and then placing the rice in a refrigerator of 4° C. for storage.

12. The method according to claim 5, wherein:
step (1) comprises the following steps: rapidly washing rice with drinking water and then draining the rice;
the step (2) comprises the following steps: instantaneous high-temperature fluidization pretreatment: conveying raw materials into a fluidization chamber to be subjected to a fluidization treatment for 50 s at a fluidization temperature of 140° C.; preparing conditioning liquid 1 containing soft rice flour, edible oil and water, wherein a mass ratio of the soft rice flour to the edible oil to the water is 0.08:0.04:1.8; after the conditioning liquid 1 is uniformly stirred by using a micro high-speed stirrer, soaking the rice for 10 min according to a mass ratio of the rice to water in the conditioning liquid 1 being 1:1.8; through a rice soup backfilling process, taking 25% of rice soup obtained by cooking to 80° C. to be added into a new system to replace part of water, and preparing conditioning liquid 2 at a proportion the same as that of the conditioning liquid 1, wherein a temperature of the whole system is maintained at about 40° C.;
and after the conditioning liquid 2 is uniformly stirred by using the micro high-speed stirrer, soaking the rice for 10 min by using the conditioning liquid 2;
the step (3) comprises the following steps: taking 25% of the rice soup for subsequent production when the cooking temperature reaches 80° C., continuing cooking for 25 min to obtain rice, and performing aseptic packaging; and
step (4) comprises the following steps: in a low-temperature environment of −20° C., rapidly cooling the rice in an air cooling mode until a center temperature of the rice is cooled to 2° C., wherein an average cooling rate is 11° C./min, and then placing the rice in a refrigerator of 0° C. for storage.

13. Instant rice prepared by the method according to claim 4.
